(19) United States
(12) Patent Application Publication
(10) Pub. No.: US 2008/0205816 A1
(43) Pub. Date: Aug. 28, 2008

(54) Integrating electrical layer on optical sub-assembly for optical interconnects

(76) Inventors: Daoqiang (Daniel) Lu, Chandler, AZ (US); Edris M. Mohammed, Hillsboro, OR (US)

Correspondence Address: COOL PATENT, P.C.;c/o INTELLEVATE, P.O. BOX 52050, MINNEAPOLIS, MN, 55402, US

(21) Appl. No.: 11/710,787

(22) Filed: Feb. 26, 2007

(51) Int. Cl. G02B 6/12

(52) U.S. Cl. 385/14; 438/29

(57) ABSTRACT

Briefly, in accordance with one or more embodiments, an optical/electrical interconnect may comprise an optical/electrical assembly having a flex panel formed thereon. The flex panel may include one or more electrical traces and/or contact pads to couple electrical traces on a substrate of the optical/electrical interconnect with an optoelectronic die disposed on the optical/electrical assembly. The flex panel may be formed on a molded sub-assembly panel via lamination, or the sub-assembly panel may be formed on the flex panel via an over-molding process, to form laminated sub-assembly panels. The laminated sub-assembly panels may be diced into one or more optical/electrical assemblies.

### BACKGROUND

Optical sub-assemblies have been proposed to be utilized in chip to chip optical interconnects. However, conventional optical sub-assemblies typically may only provide optical functionality.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a perspective view of an optical/electrical interface capable of aligning an optoelectronic die with an external waveguide in accordance with one or more embodiments;

FIG. 2 depicts a process for molding an optical/electrical sub-assembly panel for making one or more optical/electrical assemblies in accordance with one or more embodiments;

FIG. 3 depicts a process in which a flex panel may be laminated onto a sub-assembly panel for making one or more optical/electrical assemblies in accordance with one or more embodiments;

FIG. 4 depicts a process for forming one or more optical/electrical assemblies from a laminated sub-panel assembly in accordance with one or more embodiments;

FIG. 5 depicts a process for forming an optical/electrical assembly via an over-molding process in accordance with one or more embodiments; and

FIG. 6 depicts a graph illustrating a bandwidth comparison of a flex panel for an optical/electrical interconnect and other types of backplanes in accordance with one or more embodiments will be discussed.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

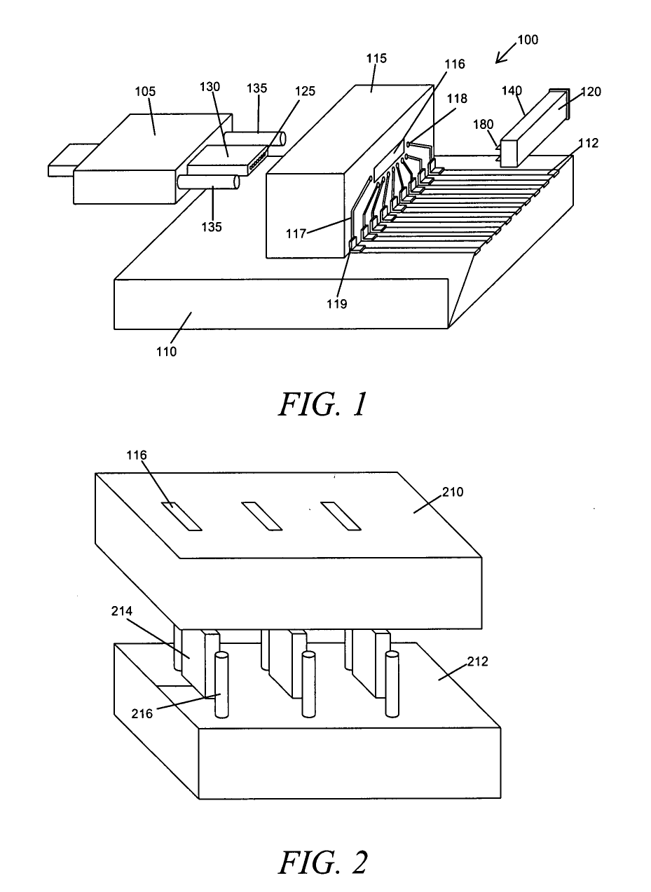

Referring now to FIG. 1, perspective view of an optical/electrical interface capable of aligning an optoelectronic die with an external waveguide in accordance with one or more embodiments will be discussed. As shown in FIG. 1, optical/electrical interconnect 100 may be capable of coupling to an external waveguide connector 105 and/or a substrate 110 in accordance with one or more embodiments. In one or more embodiments, one or more optical/electrical interconnects 100 may be utilized to provide an optical connection between two or more semiconductor integrated circuits, which may be referred to as a chip to chip connection. Optical/electrical interconnect (OEI) 100 may comprise an optical/electrical assembly (OEA) 115 and an optoelectronic (OE) die 120. Substrate 110 may include conductor traces 112 disposed on a surface thereof, and may further include various logic devices such as, for example, complementary metal oxide semiconductor (CMOS) type devices or the like (not shown) that may be electrically connected to conductor traces 112. Optical/electrical assembly 115 may include a waveguide port 116, conductor traces 117, and/or conductor pads 118 and 119. External waveguide connector 105 may include one or more waveguides 125, male couplers 130, and/or one or more alignment pins 135.

In one or more embodiments, optoelectronic die 120 may include an array of optical ports 140 to couple with waveguides 125 of connector 105. Optoelectronic die 120 may be an interface point for converting between the electrical based signals and optical based signals. As such, one or more optical sources and/or one or more optical detectors may be integrated within optoelectronic die 120.

Coupler 130 of connector 105 may be shaped to mate with port 116 of optical/electrical assembly 115. In one or more embodiments, port 116 and coupler 130 may mate to passively align external waveguides 125 housed within coupler 130 with optical ports 140 disposed on optoelectronic die 120. External waveguide connector 105 may include alignment pins 135 capable of mating with corresponding alignment pin holes formed within optical/electrical assembly 115. Insertion of alignment pin 135 into the alignment pin holes within the optical/electrical assembly 115 may passively align external waveguides 125 to butt connect with one or more of the optical ports of optoelectronic die 120 with high alignment precision. Once connected, optical signals may be communicated between external waveguides 125 and optoelectronic die 120.

In one or more embodiments, optoelectronic die 120 may comprise a semiconductor material, such as silicon, gallium arsenide, other III V semiconductors, or the like. Optoelectronic die 120 may include integrated optoelectronic devices, such as an optical source and/or an optical detector. One or more such optical sources may be electrically coupled with and/or responsive to a portion of the electrical ports to generate optical signals for transmission through external waveguides 125 via the optical ports of optoelectronic die 120. In turn, electrical ports may be coupled to conductor pads 118 via electrical connections, such as solder bumps 180 disposed on optoelectronic die 120, other surface mount connections, or the like. Conductor pads 118 may couple to conductor traces 117, conductor pads 119, and/or conductor traces 112 to couple electrical signals from external electrical devices mounted on substrate 110. While a portion of conductor traces 112 may deliver electrical signals into optoelectronic die 120 for modulating the optical sources, a portion may also deliver power for driving the optical sources.

One or more optical detectors may also be integrated within optoelectronic die 120 for receiving optical signals from external waveguides 125 and/or for generating electrical signals in response thereto. Such optical detectors may be coupled to another portion of the electrical ports to deliver the generated electrical signals to the external electronic devices disposed on substrate 110 via conductor traces 117 and 112. Accordingly, a portion of conductor traces 112 may carry electrical signals from the optical detectors of optoelectronic die 120 or deliver power into optoelectronic die 120 for operating the optical detectors. Further details of the structure and/or function of optical/electrical interface 100 is described in U.S. Pat. No. 7,068,892 which is hereby incorporated by reference in its entirety.

Referring now to FIG. 2, a process for molding an optical/electrical sub-assembly panel for making one or more optical/electrical assemblies in accordance with one or more embodiments will be discussed. As shown in FIG. 2, mold 212 may be used to mold sub-assembly panel 210 to ultimately form one or more optical/electrical assemblies 115 as shown in FIG. 1. Mold 212 may include an array of one or more extensions 214 and/or 216 corresponding to coupler 130 and/or pins 135 of connector 105 to form ports 116 and/or pin holes (not shown) in sub-assembly panel 210 capable of receiving coupler 130 and/or pins 135 therein in optical/electrical subassemblies 115 when in completed form during use as part of optical/electrical interconnect 100. In one or more embodiments, sub-assembly panel 210, although the scope of the claimed subject matter is not limited in this respect.

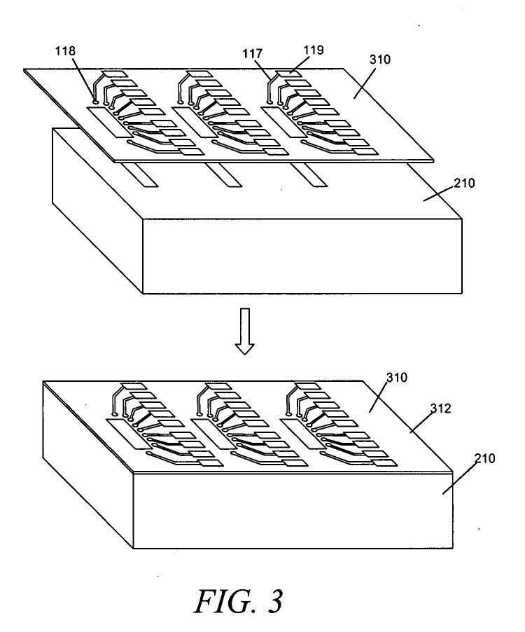

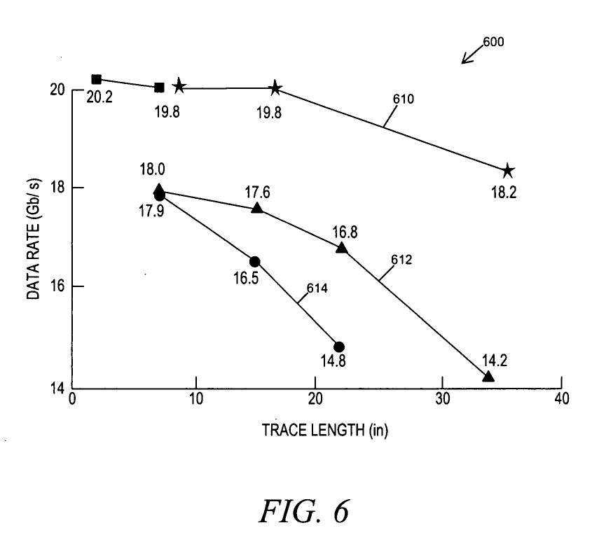

Referring now to FIG. 3, a process in which a flex panel may be laminated onto a sub-assembly panel for making one or more optical/electrical assemblies in accordance with one or more embodiments will be discussed. As shown in FIG. 3, flex panel 310 may include one or more conductor traces 117, and/or conductor pads 118 and 119 formed thereon. Flex panel 310 may comprise, for example, a polyimide material and may be further capable of operational speeds on the order of 20 gigabits per second, for example as shown in FIG. 6, below. Flex panel 310 may be disposed on sub-assembly panel 210 via lamination or a similar process. Optionally, one or more fiducials (not shown) may be formed on flex panel 310 and/or sub-assembly panel 210 to precisely align flex panel 310 on sub-assembly panel 210. When flex panel 310 is laminated onto sub-assembly panel 210, a laminated sub-assembly panel 312 may be formed, although the scope of the claimed subject matter is not limited in this respect.

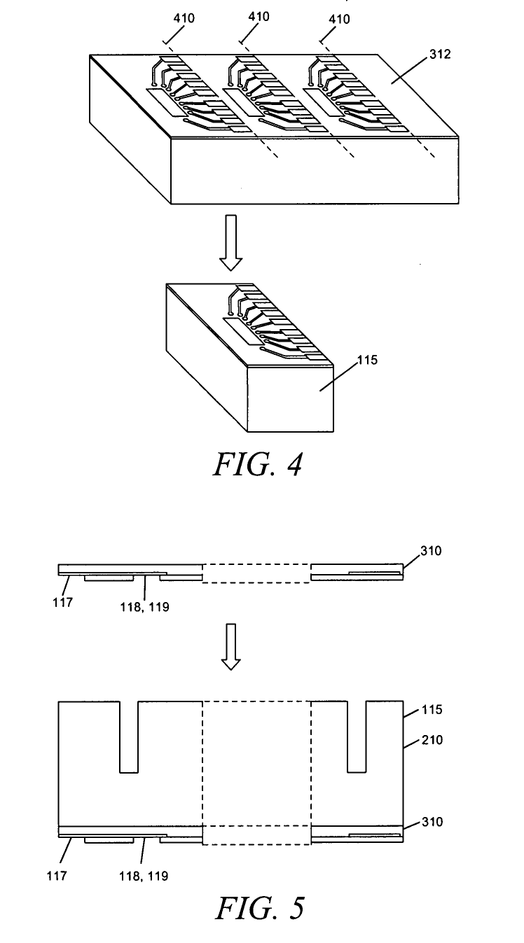

Referring now to FIG. 4, a process for forming one or more optical/electrical assemblies from a laminated sub-panel assembly in accordance with one or more embodiments will be discussed. As shown in FIG. 4, once laminated sub-assembly panel 312 is formed, individual optical/electrical assemblies 115 may be formed by dicing laminated sub-assembly panel 312 along one or more dicing lines 410. The resulting optical/electrical assemblies 115 may then be utilized to construct one or more optical/electrical interconnects 100 by disposing an optical/electrical assembly 115 on substrate 110, although the scope of the claimed subject matter is not limited in this respect.

Referring now to FIG. 5, a process for forming an optical/electrical assembly via an over-molding process in accordance with one or more embodiments will be discussed. As shown in FIG. 5, flex panel 310 may have port 116 formed thereon, in addition to one or more conductor traces 117, and/or conductor pads 118 and 119, and placed into a mold. In one or more embodiments, to precisely control the position of flex panel 310 in the mold, one or more higher precision features such as holes (not shown) may be formed on flex panel 310. Then sub-assembly panel 210 may be over-molded on top of flex panel 310 to form laminated sub-assembly panel 312. Optionally, laminated sub-assembly panel 312 may then be diced into one or more optical/electrical assemblies 115, although the scope of the claimed subject matter is not limited in this respect.

Referring now to FIG. 6, a graph illustrating a bandwidth comparison of a flex panel for an optical/electrical interconnect and other types of backplanes in accordance with one or more embodiments will be discussed. As shown in FIG. 6, graph 600 shows data rate in gigabits per second plotted versus trace length measured in inches. Plot 610 shows bandwidth data for flex panel 310 with connectors. Plot 612 shows bandwidth data for a Rogers type backplane. Plot 614 shows bandwidth data for an FR-4 type backplane. As can be seen from graph 600, flex panel 310 may provide a higher bandwidth when utilized in optical/electrical interconnect 100 as shown in FIG. 1, although the scope of the claimed subject matter is not limited in this respect.

Although the claimed subject matter has been described with a certain degree of particularity, it should be recognized that elements thereof may be altered by persons skilled in the art without departing from the spirit and/or scope of claimed subject matter. It is believed that the subject matter pertaining to integrating an electrical layer on an optical sub-assembly for optical interconnects and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

1. A method, comprising:
molding an optical sub-assembly panel, wherein said molding comprises molding one or more optical ports, one or more connector receptacles, or one or more alignment pin holes, or combinations thereof, in the optical-subassembly panel;
laminating a flex panel onto the optical sub-assembly panel to form a laminated optical sub-assembly panel; and
dicing the laminated optical sub-assembly panel into one or more optical/electrical assemblies.

2. (canceled)

3. A method as claimed in claim 1, said flex panel including one or more electrical traces or one or more electrical contact pads, or combinations thereof, formed thereon.

4. A method as claimed in claim 1, said flex panel comprising a polyimide type material.

5. A method as claimed in claim 1, said molding comprising a precision molding process.

6. A method as claimed in claim 1, said molding comprising an over-molding process.

7. A method as claimed in claim 1, further comprising assembling an optical/electrical interconnect by disposing one or more of the optical/electrical assemblies on a substrate of the optical electrical interconnect.

8. An apparatus, comprising:
an optical/electrical assembly;
a flex panel disposed on said optical/electrical assembly; and
an optoelectronic die having one or more optical ports disposed thereon, said optoelectronic die being capable of converting electrical signals into optical signals, or optical signals into electrical signals, or combinations thereof;
said optical/electrical assembly having a port formed therein to couple with a coupler of a waveguide connector, and having one or more alignment pin holes formed therein to passively align external waveguides housed in the coupler with the one or more optical ports of the optoelectronic die.

9. An apparatus as claimed in claim 8, said flex panel having one or more electrical traces or one or more contact pads, or combinations thereof, formed thereon.

10. An apparatus as claimed in claim 8, said flex panel comprising a polyimide type material.

11. An apparatus as claimed in claim 8, said optical/electrical assembly having one or more optical ports, one or more connector receptacles, or one or more alignment pin holes, or combinations thereof, formed thereon.

12. An apparatus as claimed in claim 8, further comprising an optoelectronic die disposed on said optical/electrical assembly, said optical electronic die being capable of converting electrical signals into optical signals, or optical signals into electrical signals, or combinations thereof.

13. An apparatus as claimed in claim 8, further comprising a substrate having one or more electrical traces formed thereon capable of coupling with one or more electrical traces of said flex panel.

14. An apparatus as claimed in claim 8, further comprising:
a substrate having one or more electrical traces formed thereon capable of coupling with one or more electrical traces of said flex panel; and
wherein the electrical traces on said substrate are capable of coupling with said optoelectronic die via the one or more electrical traces of said flex panel.

15. An apparatus as claimed in claim 8, further comprising:
wherein said optoelectronic die is capable of coupling with a waveguide disposed in an optical port of said optical/electrical assembly to couple the waveguide with one or more electrical traces formed on said flex panel.
